(19) United States
(12) Patent Application Publication
(10) Pub. No.: US 2012/0005106 A1
(43) Pub. Date: Jan. 5, 2012

(54) CUSTOMER CARE BASED ON SOCIAL MEDIA

(75) Inventor: Tod Famous, Ayer, MA (US)

(73) Assignee: Cisco Technology, San Jose, CA (US)

(21) Appl. No.: 12/827,712

(22) Filed: Jun. 30, 2010

(51) Int. Cl. G06Q 10/00; G06F 17/30

(52) U.S. Cl. 705/304; 707/812; 707/E17.005; 707/E17.009

(57) ABSTRACT

In one implementation, the information available in social networking services is leveraged by a customer service agent. Recent social media posts by customers may be accessed by a call center server either at the time of a customer service request or ahead of time. If the customer has provided any information in the social media posts related to why the customer is calling in, the customer service agent can save valuable time that is usually spent finding the source of the problem. The call center server includes a communication interface operable to receive a customer service request including a customer identity and a controller configured to query at sources of social media postings based on the customer identity. The call center server may transmit the social media postings to a device for displaying the social media postings to the customer service agent.

### FIELD

The present embodiments relate to customer service.

### BACKGROUND

Customer call centers often keep databases of their customers. When a customer calls in for technical support, warranty, or other assistance, the customer's phone number, account number, or other identifying information may be used to access the customer's record in a database. The database is populated with information given to the customer call center by the customer. When the customer reports a problem, the customer call center staff has little to no context about the problem. Normally, the customer call center staff has only the basic info on the account accessed by the account number or customer's name. The customer must start from the beginning to explain the situation, and the call center staff builds a record of the problem.

### BRIEF DESCRIPTION OF THE DRAWINGS

FIG. 1 illustrates a customer call center.

FIG. 2 illustrates an agent desktop in the customer call center of FIG. 1.

FIG. 3 illustrates a customer database coupled with the customer call center of FIG. 1.

FIG. 4 illustrates a flow chart of customer care utilizing social media postings.

### DETAILED DESCRIPTION

### Overview

The key to customer service is speed and accuracy. Faster communication leads to better customer service. Leveraging the information available in social networking services gives a customer service agent a head start in providing customer service and provides context to help the agent interpret the problem reported by the customer. Although some social networking services are largely private and not freely accessible, many are publicly accessible. A call center often has enough information (name, email, and location) to identify customers' profiles in social network services and in some cases customers volunteer access to their social network profiles. Recent social media posts by customers may be accessed either at the time of a customer service request or ahead of time. If the customer has provided any information in the social media posts related to why the customer is calling in, the customer service agent can save valuable time that is usually spent finding the source of the problem. A recent statement in the social media posts such as “Username: is sick of these high cell phone bills” indicates to the customer service agent that he should start with a different line of questions than if the social media posts includes “Username: great, the dog just chewed up my cell phone.”

In one aspect, a method includes receiving a customer service request including an identity of a customer, wherein the customer service request originates with a communication by the customer, accessing at least one social media posting based on the identity, and transmitting the at least one social media posting to a customer service device for display.

In a second aspect, an apparatus includes a communication interface operable to receive a customer service request including a customer identity, and a controller configured to query at least two sources of social media postings based on the customer identity, wherein the communication interface transmits the social media postings to an external device.

In a third aspect, logic encoded in one or more non-transitory tangible media is executable by a processor and operable to populate a database with social media postings by querying at least one social media host with a plurality of addresses, receive a customer service request from an agent device, wherein the request identifies a customer identity, access the database with the customer identity to retrieve a set of social media postings, and transmit the set of social media postings to an external device.

### EXAMPLE EMBODIMENTS

Social media hosts provide social network services. A social network service may be any service in which the content is generated by the users. Many social network services are websites accessed through a uniform resource locator (URL). Social network services may include a “profile” or “page” for each user to add content, and each user shares the user's profile or page with other users. Some profiles are public and accessible by anyone, while others are private and accessible only by selected other users, which may be referred to as friends or contacts.

Consumers use social network services to communicate. Often, this means that consumers post about the products they use, especially when they have a problem. For example, a cell phone customer may comment about poor reception in a particular area, or a television customer may comment that his basement flooded, damaging the television. Sometimes the posting may describe the particular problem in detail, including the location where the problem occurred, the date, the time of day, the brand/model of the device, and/or the service provider. When the consumer calls into a customer call center with a problem or to purchase/upgrade products or services, this information may be particularly useful to the agent receiving the call. The customer call center that taps into the wealth of information available from social network services can provide more efficient customer service to customers.

Social network services take many forms, each allowing users to create social media postings. One form is a profile based social network service. In a profile based social network service, users create a profile as representations of themselves. The profiles often include photographs, likes and dislikes, and other user generated content. Many profiles also include a contact list used to connect to other users' profiles and access the other users' content. Profile based social network services focus on the relationships among people, which includes groups of people who share interests or are friends for any reason. Most profile based social network services are accessed via the internet using a URL. One key to the profile based social network is the connections among users. Examples of profile based social networks include Facebook, MySpace, Linkedln, and Bebo. Most profile based social networks include an area for comment by the user and by other users. In addition, many profile based social networks include a status message feature, which is an example of a microblog.

The microblog is another form of a social network service. A microblog entry includes an entry relatively small in content as compared with other sources. A microblog entry could consist of a sentence, a sentence fragment, an image, or an embedded video. The most common subject of microblog entries relate to what the user is doing at that moment or that day and what the user is thinking about. Microbloggers often post about their experiences with products and services. A microblogger may complain that his television has stopped working or that his digital video recorder (DVR) is stuck on the wrong time zone. This type of information has particular value to the vendors of the television and DVR. In addition, microbloggers may provide other information about their lives that allow inferences about the customer's problems. Examples of microblogs include the Facebook status update, Twitter, and Tumblr.

Another form of a social network service is a traditional blog. A blog may relate to any variety of topics often in the form of a personal diary of commentary. Blogs may be accessed by a URL. In addition, some blog hosts provide usernames for user. Examples of blog hosts are Blogger, Wordpress, and Blogspot. Other hosts may be used, such as individually assigned websites.

Another form of a social network service is a community forum. Community forums include any message board where users share ideas and comments. Some community forums focus on a particular product or company. For example, there are message boards related to particular models of cell phone, laptops, and other products. Some companies may host a message board related to the company's products.

A location based social network service utilizes global positioning systems (GPS) to incorporate users' real world locations into the social network. For example, location based social network services may be access via a GPS enabled mobile device, which may be a cellular phone, a laptop computer, a smart phone, a tablet device, or a personal digital assistant (PDA). Users may comment from the mobile device regarding the products or services available at the users' current locations. The vendors at the users' location may offer coupons or specials to the users. An example of a location based social network service is Foursquare. A location based social network service may integrate with another social network service such as Facebook.

Another form of a social network service is a business oriented social network service, which allows users to maintain a list of contact details of people they know and trust in business and maintain a profile of the user's own business experience. The business oriented social network service may also allow users to post messages. An example of a business oriented social network service is Linkedln.

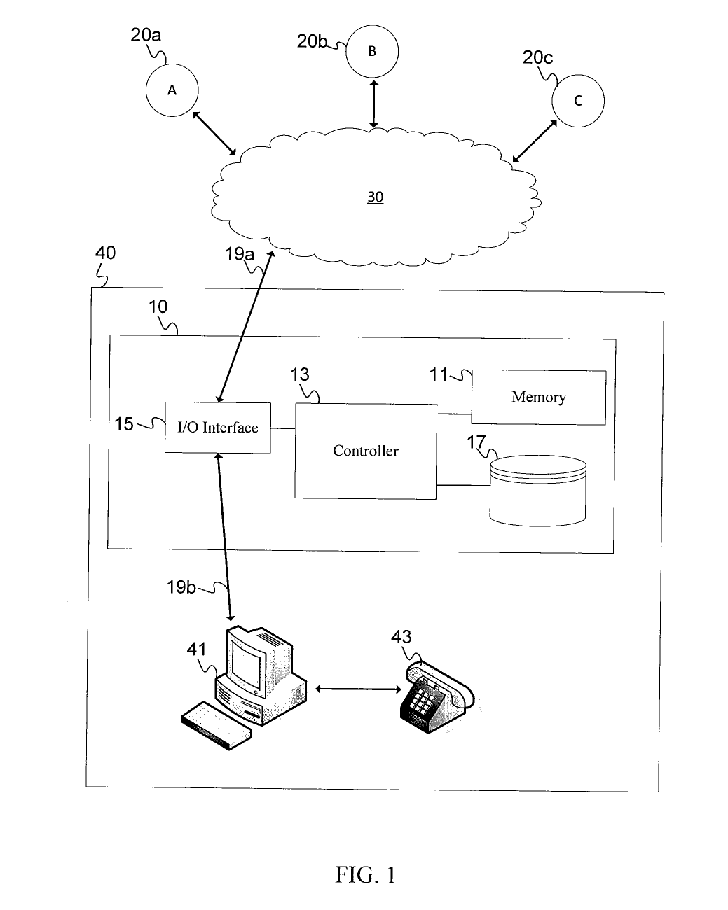

FIG. 1 illustrates a customer call center 40 connected to a network 30 via communication path 19a. The network 30 may be the Internet or a local area network (LAN). The network 30 or communication path 19a provides access to social network services 20a-c. Additional or fewer social network services may be used. The customer call center 40 includes a call center server 10, which is connected to agent device 41 and agent phone 43. The call center server 10 includes a controller 13, a memory 11, an input/output (I/O) interface 15 (communication interface), and a database 17. Additional, different, or fewer components may be provided.

The customer call center 40 receives a call from a customer. Based on caller identification (ID) or an interactive voice response (IVR) system, the agent device 41 or server 10 identifies the customer. The agent device 41 or server 10 sends the customer identity to the call center server 10 as a customer service request, and the I/O interface 15 receives the customer service request including the customer identity. The controller 13 is configured to access social media postings based on the customer identity. By way of I/O interface 15, the call center server 10 transmits the social media postings to an external device, which may be agent device 41 or phone 43.

In one implementation, the call center server 10 monitors social network services for relevant information. The call center server 10 may monitor social network services periodically based on a predetermined time period. For example, the predetermined time period may be every night at midnight for each of a list of known customers.

In another implementation, the call center server 10 accesses social media postings on the fly, when the customer service request is received. The controller 13 may access the social media postings based on a trigger. The trigger may be the phone call from the customer. Alternatively, the call center server 10 may be configured to access the social media postings when the customer is placed in a queue, and sufficient time remains for the compilation of the social media postings. The IVR system may prompt the user to enter information regarding social network services before the call is placed in queue or forwarded to the agent. For example, the customer may be prompted to enter an email address, a URL, a profile ID, or a username.

In one example, the call center server 10 may include an operating system and a software application. The operating system may be Linux based or Windows based. The call center server 10 may be implemented as a virtual machine.

The memory 11 may be any known type of volatile memory or a non-volatile memory. The memory 11 may include one or more of a read only memory (ROM), dynamic random access memory (DRAM), a static random access memory (SRAM), a programmable random access memory (PROM), a flash memory, an electronic erasable program read only memory (EEPROM), static random access memory (RAM), or other type of memory. The memory 11 may include an optical, magnetic (hard drive) or any other form of data storage device. The memory 11 may be located in a remote device or removable, such as a secure digital (SD) memory card.

The database 17 may be external to the call center server 10 or incorporated within the call center server 10. The database 17 may be stored with memory 11 or separately. The database 17 may be implemented as either hardware or software.

The memory 11 may store computer executable instructions. The controller 13 may execute computer executable instructions. The computer executable instructions may be included in computer code. The computer code may be stored in the memory 11. The computer code may be written in any computer language, such as C, C++, C#, Java, Pascal, Visual Basic, Perl, HyperText Markup Language (HTML), JavaScript, assembly language, extensible markup language (XML) and any combination thereof.

The computer code may be logic encoded in one or more tangible media or one or more non-transitory tangible media for execution by the controller 13. Logic encoded in one or more tangible media for execution may be defined as instructions that are executable by the controller 13 and that are provided on the computer-readable storage media, memories, or a combination thereof. Instructions for instructing a network device may be stored on any logic. As used herein, “logic,” includes but is not limited to hardware, firmware, software in execution on a machine, and/or combinations of each to perform a function(s) or an action(s), and/or to cause a function or action from another logic, method, and/or system. Logic may include, for example, a software controlled microprocessor, an ASIC, an analog circuit, a digital circuit, a programmed logic device, and a memory device containing instructions.

The instructions may be stored on any computer readable medium. A computer readable medium may include, but is not limited to, a floppy disk, a hard disk, an application specific integrated circuit (ASIC), a compact disk CD, other optical medium, a random access memory (RAM), a read only memory (ROM), a memory chip or card, a memory stick, and other media from which a computer, a processor or other electronic device can read.

The controller 13 may include a general processor, digital signal processor, application specific integrated circuit, field programmable gate array, analog circuit, digital circuit, server processor, combinations thereof, or other now known or later developed processor. The controller 13 may be a single device or combinations of devices, such as associated with a network or distributed processing. Any of various processing strategies may be used, such as multi-processing, multi-tasking, parallel processing, remote processing, centralized processing or the like. The controller 13 may be responsive to or operable to execute instructions stored as part of software, hardware, integrated circuits, firmware, micro-code or the like. The functions, acts, methods or tasks illustrated in the figures or described herein may be performed by the controller 13 executing instructions stored in the memory 11. The functions, acts, methods or tasks are independent of the particular type of instructions set, storage media, processor or processing strategy and may be performed by software, hardware, integrated circuits, firmware, micro-code and the like, operating alone or in combination. The instructions are for implementing the processes, techniques, methods, or acts described herein.

The I/O interface 15 may include any operable connection. An operable connection may be one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other or through one or more intermediate entities (e.g., processor, operating system, logic, software). Logical and/or physical communication channels may be used to create an operable connection. For example, the I/O interface 15 may comprise a first communication interface devoted to sending data, packets, or datagrams and a second communication interface devoted to receiving data, packets, or datagrams. Alternatively, the I/O interface 15 may be implemented using a single communication interface.

The communication paths 19a-b may be any protocol or physical connection that is used to couple a server to a computer. The communication paths 19a-b may utilize Ethernet, wireless, or TCP/IP technologies. As used herein, the phrases “in communication” and “coupled” are defined to mean directly connected to or indirectly connected through one or more intermediate components. Such intermediate components may include both hardware and software based components.

The agent device 41 may be a personal computer also including a processor and a memory according to the alternatives above. The agent device 41 may execute software displaying the social media postings accessed by controller 13. Alternatively, the agent device 41 may access a website using a hypertext transfer protocol (HTTP) browser by accessing a URL on call center server 10.

The agent phone 43 may be an IP phone. In one example, the agent phone 43 is integrated into the agent device 41. In another example, the agent phone 43 may be directly connected to the communication path 19b. Alternatively, the agent phone 43 may be coupled with a public switched telephone network (PSTN) and/or a private branch exchange (PBX), and the calls may be routed using a call center manager.

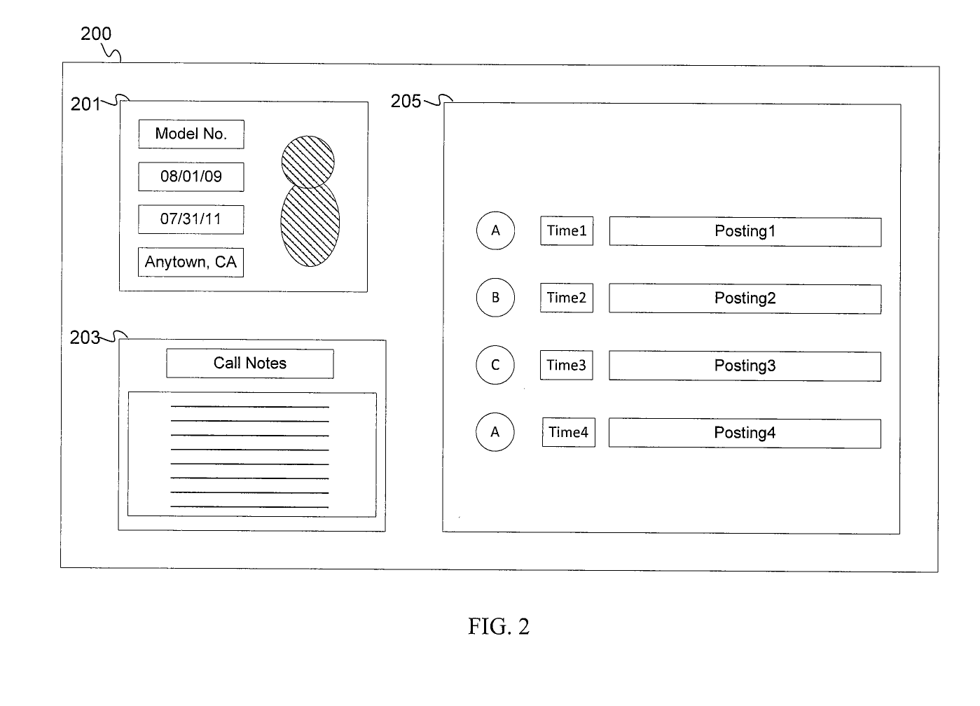

FIG. 2 illustrates an agent desktop 200 as displayed on agent device 41. The agent desktop 200 may be a software application running on the agent device 41 or a web-based application accessed by the agent device 41. The agent desktop 200 includes account information 201, call notes 203, and social media timeline 205. The agent desktop 200 may be a screen pop that is triggered by the customer's call being connected with agent phone 43. Other formats and/or types of information may be used.

The account information 201 includes information related to customer and/or product, which may include information such as the model number, the purchase date, the end of contract date, the end of warranty date, the location of the purchase, the customer's balance, and/or the location of the customer. The account information 201 may include an image of the product or the customer, which may be downloaded from one or more of the social network services.

The call notes 203 include information added by the call agent during telephone calls. The call notes 203 may be indexed with a time stamp. The call notes 203 contain information obtained from a customer in one call that can be used by the call agent in the next call.

The social media timeline 205 includes social media postings. The social media postings are accessed from social networking services 20a-c. The social media postings may be presented in chronological order. For example, the social media postings from one or more of the various social network services may be interleaved according to time stamps. The social media timeline 205 is a timeline of the total activities, regardless of whether the activities are related, of a particular user. The social media timeline 205 is organized around the person. Other organizations may be used.

The social media postings may be limited by a configurable parameter. The configurable parameter may be a time range for the social media postings. The time range may be set at, for example, a day, a week, a month or the time since the customer last called in. The time range may be a predetermined time range or it may be set by the agent device 41. The call center server 10 may filter the plurality of social media postings according to the configurable parameter.

In addition or in the alternative, the configurable parameter may be a relevance factor of the social media postings. The relevance factor may be determined by the call center server 10 according to a set of keywords. The set of keywords may be chosen based on the words typically used by consumers in need of customer assistance.

The call center server 10 may filter the social media postings according to a product identity. The product identity may be a brand name, a service name, a model number or other keywords indicative of a particular product or service or other mining criteria.

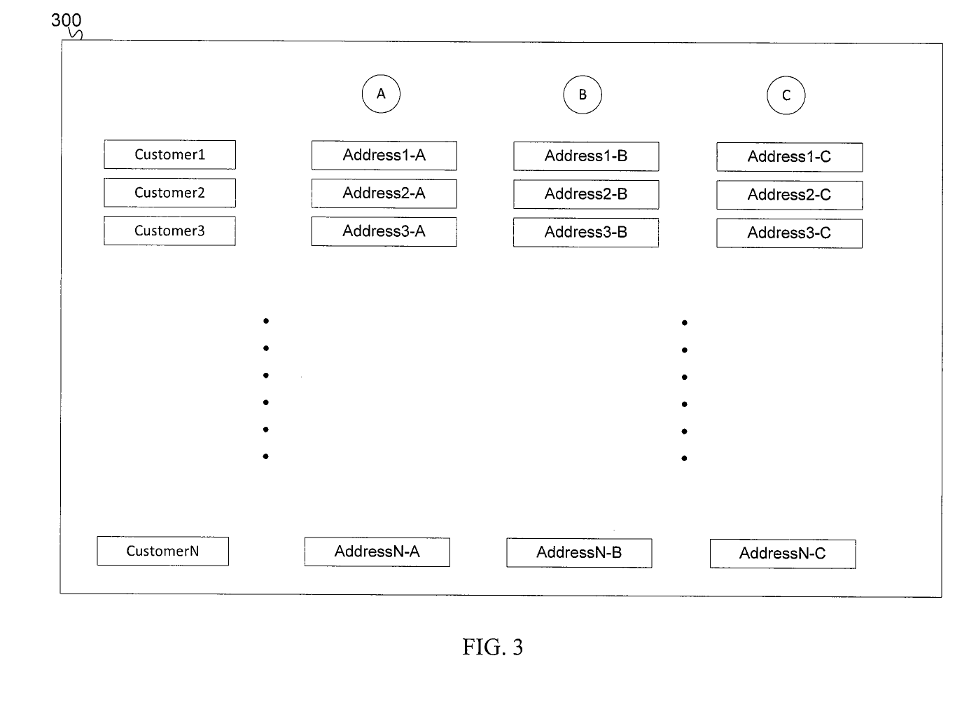

FIG. 3 illustrates a customer address database 300 coupled with the customer call center of FIG. 1. The customer address database 300 may be stored in database 17 or memory 11. The customer address database includes a list of customer identities. Each customer identity is matched with one or more social network services by username, URL, email address, or other identification. For example, customer1 may be a an account number or customer name connected to Address1-A, which is a Facebook URL, Address1-B, which is a twitter ID, and Address1-C, which is a blog URL. The call center server 10 may query social media hosts using the address indexed by customer identity, and the communication interface 15 transmits the social media postings to an external device, such as agent device 41.

Social media postings may be either public or private. Public postings may be accessed simply by knowledge of the customer's name or URL. The customer may disclose the location of public postings through a questionnaire email, a prompt on the IVR system, a warranty card, or by the request of the customer service agent. Public postings may even be located by simply using a search engine with the customer's name or other identification. Another example of public postings is “fanpages” popular on Facebook where customers create social media postings on the fanpage of a particular product, service, or company.

Private postings, on the other hand, may only be accessed with the customer's permission. However, the customer call center may send an electronic request, such as a friend request, to the customer. The request may be sent in response to the customer disclosing that the customer uses social networking service in a questionnaire email, a prompt on the IVR system, a warranty card, in response to a communication to the call center, or by the request of the customer service agent.

The customer call center may have access to some private social media postings that were made on the vendor's system. For example, some vendors may have forums or message boards where customers post about their successes and problems with products. Other customers or employees of the vendor help them via the message board. These social media postings are particularly relevant to the reason that the customer is calling in.

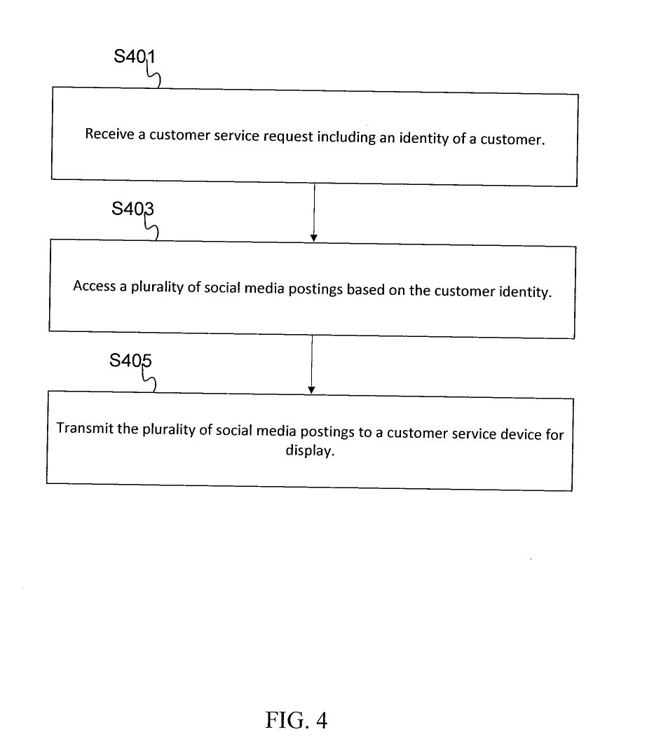

FIG. 4 illustrates a flow chart of customer care utilizing social media postings. At block S401, the call center server 10 receives a customer service request including an identity of a customer. The customer service request originates with a communication by the customer. In one example, the customer service agent receives communication by the customer and agent device 41 and/or phone 43. The agent device 41 may generate the customer service request for transmission to the call center server 10. At block S403, the call center server 10 accesses a plurality of social media postings based on the customer identity. The postings are accessed at that time from the social media host(s) or from either database 17 or memory 11 populated by previous access to the social media host(s). At block S405, the call center server 10 transmits the plurality of social media postings to a customer service device for display. The customer service agent may interact the customer based on the social media postings. For example, if the social media postings indicate that the customer has recently moved, the customer service agent may suggest a change of address or a transfer of service.

In the alternative to a call received on agent phone 43, the customer may contact the call center via instant message, email or chat service. The embodiments disclosed herein may be applied to these alternate forms of communication.

Additionally, the call center may gather information from the social media postings to trigger outbound communication to customers. The outbound communication may be in the form of a phone call, email, or text message. In addition, the outbound communication may be made in the setting of the social media host, for example, the agent may send a Facebook message or a Tweet to the customer.

Various embodiments described herein can be used alone or in combination with one another. The foregoing detailed description has described only a few of the many possible implementations of the present invention. For this reason, this detailed description is intended by way of illustration, and not by way of limitation.

I (we) claim:

1. A method comprising:
receiving a customer service request including an identity of a customer, wherein the customer service request originates with a communication by the customer;
accessing at least one social media posting based on the identity; and
transmitting the at least one social media posting to a customer service device for display.

2. The method of claim 1, further comprising:
filtering the at least one social media posting according to a configurable time range for the at least one social media posting.

3. The method of claim 1, further comprising:
filtering the at least one social media posting according to a relevance factor of the at least one social media posting.

4. The method of claim 1, further comprising:
monitoring social media postings according to a customer list; and
storing social media postings in a social media database, wherein the social media database is accessed based on the customer identity when the customer service request is received.

5. The method of claim 1, wherein the at least one social media posting is accessed via the internet when the customer service request is received.

6. The method of claim 1, wherein the at least one social media posting includes a plurality of social media postings accessed from two or more social media hosts.

7. The method of claim 6, further comprising:
interleaving the plurality of social media postings chronologically regardless of originating social media host.

8. The method of claim 6, further comprising:
an address database, wherein the two or more social media hosts include a first social media host and a second media host and the address database links the customer database to a first address related to the first social media host and a second address related to the second media host.

9. The method of claim 1, further comprising:
identifying the accessed at least one social media posting according to a product identity.

10. An apparatus, comprising:
a communication interface operable to receive a customer service request including a customer identity; and
a controller configured to query at least two sources of social media postings based on the customer identity, wherein the communication interface transmits the social media postings to an external device.

11. The apparatus of claim 10, wherein the controller is further configured to filter the social media postings according to at least one of time range of the social media postings, a relevance factor of the social media postings, and a product identity.

12. The apparatus of claim 10, wherein the social media postings are accessed via the internet when the customer service request is received.

13. The apparatus of claim 10, wherein the controller interleaves the social media postings chronologically regardless of source.

14. The apparatus of claim 10, further comprising:
an address database, wherein the at least two sources include a first social media host and a second media host and the address database links the customer database to a first address related to the first social media host and a second address related to the second media host.

15. Logic encoded in one or more non-transitory tangible media, the logic executable by a processor and operable to:
populate a database with social media postings by querying at least one social media host with a plurality of addresses;
receive a customer service request from an agent device, wherein the customer service request identifies a customer identity;
access the database with the customer identity to retrieve a set of social media postings; and
transmit the set of social media postings to a customer service device for display.

16. The logic of claim 15, further operable to:
update the database after the customer service request is received.

17. The logic of claim 15, further operable to:
filter the social media postings according to at least one of a time range of the social media postings, a relevance factor of the social media postings, and a product identity.

18. The logic of claim 15, wherein the at least one social media host includes at least two social media hosts and the social postings are interleaved chronologically regardless of social media host.

19. The logic of claim 15, wherein the social media postings are publicly accessible.

20. The logic of claim 15, further operable to:
request access to private social media postings through a communication sent within the at least one social media host.
